(19) United States
(12) Patent Application Publication
(10) Pub. No.: US 2017/0368407 A1
(43) Pub. Date: Dec. 28, 2017

(54) Children's Yoga Mats and Methods of Use

(71) Applicant: Lysander Wright, Lynn, MA (US)

(72) Inventor: Lysander Wright, Lynn, MA (US)

(21) Appl. No.: 15/626,290

(22) Filed: Jun. 19, 2017

Related U.S. Application Data
(60) Provisional application No. 62/354,729, filed on Jun. 25, 2016.

(51) Int. Cl. A63B 21/00; G09B 19/00

(52) U.S. Cl. CPC A63B 21/4037; A63B 21/4027; G09B 19/0038

(57) ABSTRACT

The present invention is a shaped yoga mat and methods of using the inventive yoga mat that are directed towards instructing children. The inventive yoga mats have a flat center and a fringe area extending away laterally. The fringe area can be cut or trimmed into a variety of shapes that appeal to children, such as an animal or vehicle. A yoga instructor can then use the uniquely shaped yoga mats to spark a child's imagination through the use of exercises with a theme related to the yoga mats.

### CROSS REFERENCE TO RELATED APPLICATIONS

This application claims the benefit of U.S. Provisional Patent Application No. 62/354,729 filed Jun. 25, 2016, which is hereby incorporated by reference in its entirety.

### FIELD OF THE INVENTION

The present invention relates to yoga mats and methods of use related to yoga mats, in particular, to yoga mats cut into one or more shapes and methods of using the yoga mats to encourage children to practice yoga.

### BACKGROUND OF THE INVENTION

Yoga is a type of spiritual exercise that seeks to fulfil a person physical, mentally and spiritually. Yoga exercises can include holding yoga poses, breathing exercises and stretching exercises, as well as meditation. While there are many documented health benefits for adults that practice yoga regularly, children have largely been left out of the yoga craze and the potential health benefits from practicing yoga.

The currently available methods of yoga instruction and yoga mats are not conducive to keeping the attention of children and encouraging them to practice yoga. The methods of yoga instruction in the prior art focus on quiet settings where a person holds yoga poses for a period of time. Children are often unable to stay quiet for an entire yoga class or able to hold yoga poses as long as an adult.

In addition, the presently available yoga mats do not appeal to children. The yoga mats of the prior art are almost exclusively rectangular sections of cushioning material that is capable of being rolled for transport. While the yoga mats of the prior art are adequate for adults, they are not sufficient for interesting children in yoga or engaging their imagination.

Therefore, there is a need for a method of yoga instruction that is able to engage children in yoga. There is also a need for a yoga mat that is capable of interesting children in yoga.

### BRIEF SUMMARY OF THE INVENTION

The present invention provides yoga mats in unique shapes and a method of instruction to interest children in practicing yoga using the mats. The embodiments presented in this application are optimized for use as a yoga mat, however, it is appreciated that the invention could be used in other applications, such as, but not limited to exercise mats and playroom mats, within the inventive concept expressed herein.

In a first exemplary embodiment, the present invention is comprised of at least one yoga mat in the shape of a mode of transportation, one or more children or students and an instructor. In this embodiment, the instructor fashions a method of yoga instruction that relates back to the shape of the yoga mat, engaging the children to image being on the actual mode of transportation to encourage them to perform yoga poses, breathing exercises, stretching exercises and meditation.

In a second exemplary embodiment, the present invention is comprised of two or more yoga mats, each in the shape of a train engine, train car or train caboose, two or more children or students and an instructor. In this embodiment, the instructor fashions a method of yoga instruction that relates back to the shapes of the yoga mats to engage the children's imagination and encourage them to practice yoga.

In other exemplary embodiments of the invention are yoga mats in the shape of a train, boat, airplane, submarine, rocket and baseball diamond.

In another exemplary embodiment, the present invention is comprised of three or more yoga mats, each in the shape of a mode of transportation, one or more children and an instructor. In this embodiment, the instructor directs a method of yoga instruction that relates to the shapes of the yoga mats to engage the children's imagination and encourage them to practice yoga.

### BRIEF DESCRIPTION OF THE SEVERAL VIEWS OF THE DRAWINGS

FIG. 1 is an isometric view of a first embodiment of the invention shown in a first method of use.

FIG. 2 is an isometric view of a second embodiment of the invention shown in a second method of use.

FIG. 3 is a top view of a third embodiment of the invention.

FIG. 4 is a top view of a fourth embodiment of the invention.

FIG. 5 is a top view of a fifth embodiment of the invention.

FIG. 6 is a top view of a sixth embodiment of the invention.

FIG. 7 is a top view of a seventh embodiment of the invention.

FIG. 8 is a top view of an eighth embodiment of the invention.

FIG. 9 is an isometric view of a ninth embodiment of the invention shown in a third method of use.

### DETAILED DESCRIPTION OF THE INVENTION

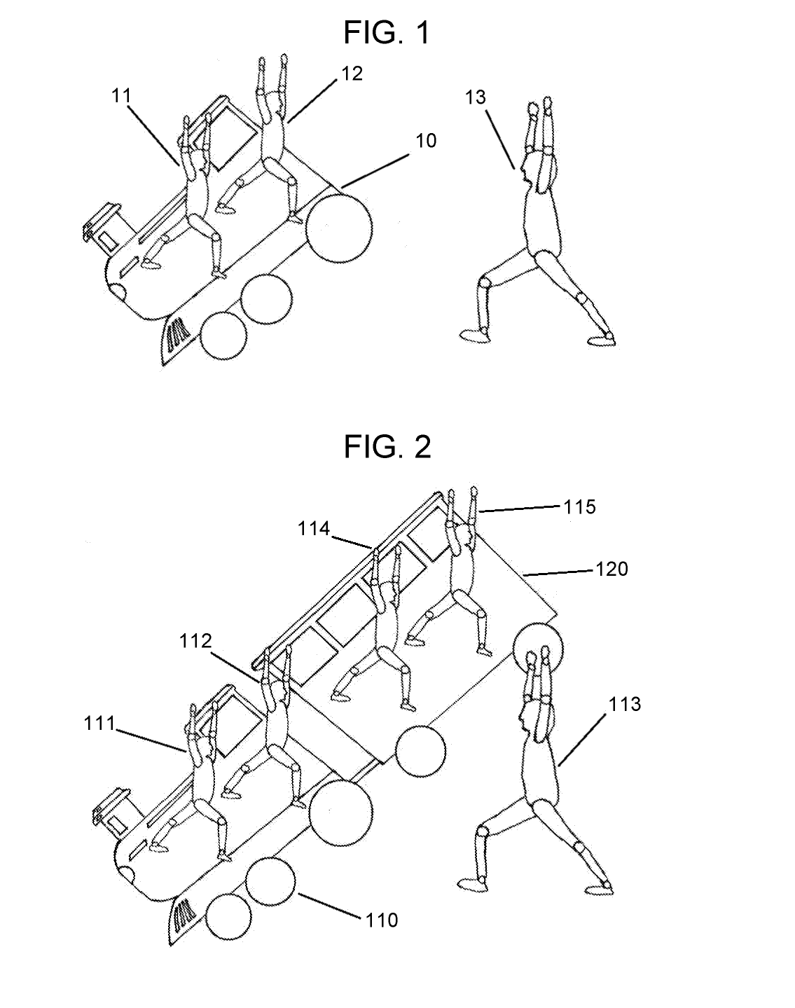

In FIG. 1 is an isometric view of a first exemplary embodiment of the invention shown in a first method of use. In the first embodiment of the invention is a mat 10 cut into the shape of a train engine or locomotive. The first embodiment may be cut from a continuous sheet of yoga mat material or cut from various pieces of yoga mat material and fixed together to form the desired shape. The terms “yoga mat material” and “material” in reference to the yoga mats of the present invention include the materials commonly used to construct yoga mats as well as other substantially flat cushioning material that would be suitable for use as a yoga mat. The yoga mats of the present invention are comprised of yoga mat material that can be laid substantially flat when in use, with a center portion large enough for at least one child to practice yoga and a fringe portion that extends laterally from the center portion and is cut to resemble the shape of a person, place or thing. The resulting mat is large enough for a child to practice yoga, but also has excess material that forms a shape that is desirable to that child. The yoga mats of the present invention serve both to encourage children to practice yoga by presenting them with a uniquely shaped mat and allow yoga instruction to be tailored to the shape of the mats to further interest children in the practice of yoga.

In the isometric view of FIG. 1, the yoga mat 10 is substantially flat and thin so as not to leave a visible raised edge at this level of magnification. In each embodiment, the solid line along the perimeter of the mat represents the outer edge of the mat when viewed from above and the lines within the perimeter represent surface treatments to the mat which can include printed lines and shapes or the edge between sections of attached mats. While the lines within the perimeter in the present invention do not represent the outline of a cutout or hole, it is appreciated that a cutout or hole could be used in certain circumstances to define a shape within the perimeter of the mat.

The first method of use is comprised of selecting a yoga mat cut into a particular shape and directing children through yoga exercises that relate back to the shape of the mat. As shown in FIG. 1, the mat 10 is cut into the shape of a train engine, two children 11 and 12 are on the mat performing a yoga pose and an instructor 13 is directing the children 11 and 12 in the practice of yoga. The instructor 13 may be either a person or an electronic means for delivering instruction, such as a television or computer. While two children 11 and 12 are pictured, the first method of use can be used for one or more children.

Yoga, in general, is comprised of performing yoga poses, stretching exercises, breathing exercises and meditation. In the first method of use, the instructor 13 first selects a yoga mat that would encourage the children 11 and 12 to participate in a yoga class. The train shaped yoga mat 10 would likely appeal to many children, but uniquely shaped yoga mats may be created to tailor the yoga instruction to that particular child. Specifically, all of the shaped yoga mats described herein may be constructed from single sheet of material or from multiple pieces of material and attached to form the shape. An image (including but not limited to a picture, drawing, logo, color or pattern) may optionally be applied to the upper surface of the yoga mat using a variety of processes. One particularly effective process of applying an image to the yoga mat is through the use of a heated ink or pigment. The heated ink or pigment is capable of a strong bond to the yoga mat material and can provide a durable surface.

Yoga mats in shapes can be produced by cutting a sheet of material into a shape and printing surface features onto the mat. Alternatively, custom yoga mats for particular students may be created by cutting pieces of yoga mat material into shapes and attaching them together to form the desired shape and pattern. In the event that a child is not interested in a yoga mat of a shape that is available, a yoga mat can be created by hand cutting either a single sheet of yoga mat material or by cutting pieces of yoga mat material of different colors and gluing or taping the pieces together to form a shape. By custom making a yoga mat for a particular child, the child can be involved in the yoga mat decision process and/or the building of the yoga mat to increase their interest in practicing yoga.

Using the train shaped yoga mat 10, an instructor 13 could direct the children 11 and 12 to perform yoga poses that are reminiscent of being on a train. For example, the instructor 13 could start by directing the children 11 and 12 to image that the train mat 10 was an actual train moving along a track. The instructor 13 could then direct the children 11 and 12 to perform the Setu Bandha Sarvangasana pose, also known as the bridge pose, and imagine traveling over a bridge on the train. The instructor 13 could then direct the children 11 and 12 to perform the Vriksasana pose, also known as the tree pose, and the Tadasana pose, also known as the mountain pose, as they imagine traveling through a forest and by a mountain, respectively, on the train. Other yoga poses that the instructor 13 may optionally add to a story about a train include the Balasana pose, also known as the flower pose, the Ardha Chandrasana pose, also known as the crescent moon pose, the rainbow pose and the star pose. While certain yoga poses have been identified herein as appropriate for relating to the train shaped mat 10, it is appreciated that many other yoga poses could be appropriate in a narrative where an instructor 10 asks children 11 and 12 to imagine being on a train.

Using the train shaped yoga mat 10, an instructor 13 could direct the children 11 and 12 to perform breathing exercises that relate to being on a train. For example, the instructor 13 could direct the children 11 and 12 to perform a hissing breathing exercise to simulate the train releasing steam from its engine. A hissing breathing exercise can include breathing through the nose, pausing, then exhaling through the mouth, making a hissing noise, and pausing again. The instructor 13 could also direct the children 11 and 12 to perform a train-like breathing exercise to mimic the sound a train makes as it chugs along. A train-like breathing exercise can include inhaling deeply and exhaling shallow breaths through the mouth in quick succession.

Other Pranayama breathing exercises commonly done in the practice of yoga could also be appropriate for the train theme or be adapted to relate to a train theme. Examples of Pranayama breathing exercises include Sama Vritti, which involves inhaling through the nose for a count of four and then exhaling through the nose for a count of four, progressive relaxation, which involves relaxing portions of the body while breathing deeply and abdominal breathing, which involves inhaling deeply through the nostrils, moving the diaphragm and slowly exhaling the through the nostrils,

Also using the train shaped yoga mat 10, an instructor 13 could direct the children 11 and 12 to meditate in methods or timing that is reminiscent of being on a train. For example, the instructor 13 could direct the children 11 and 12 to imagine that the train has stopped in a station and shut off the engine. While imaging being stopped in the station, the instructor 13 could direct the children 11 and 12 to quietly meditate for a period of time.

In FIG. 2 is an isometric view of a second exemplary embodiment of the invention shown in a second method of use. In the second embodiment of the invention is a first mat 110 cut into the shape of a train engine or locomotive and a second mat 120 cut into the shape of a train car. While the second mat 120 is shown as a train car in FIG. 2, it could optionally be a train caboose. Additional mats in the shape of train cars or a caboose may optionally be added to the right of the second mat 120. The second embodiment may also be cut from a continuous sheet of material or cut from various pieces of material and fixed together to form the desired shape.

The second embodiment allows the invention to be expanded for larger classes without increasing the size of each mat. In the second embodiment, additional mats 120 shaped as train cars can be added to accommodate the particular number of children in a class. In the second exemplary embodiment, only two children are shown on each mat 110 and 120, but it is appreciated that the mats 110 and 120 can be made larger to accommodate more children per mat or smaller so that each child has their own mat. While the first and second embodiments do not show the instructor 113 on a yoga mat, it is appreciated that the instructor may be on a standard yoga mat, a yoga mat of a specific shape as disclosed herein or not on a yoga mat at all.

In the second method of use, the instructor 113 has multiple mats 110 and 120, and more children 111, 112, 114 and 115, which gives the instructor additional options in directing the children through the practice of yoga. Since the mats 110 and 120 are train themed, all of the yoga poses, breathing exercises and meditation exercises of the first method are appropriate for use in the second method of use.

The addition of the second mat 120 in the shape of a train car or caboose allows the instructor 113 to direct the children 111 and 112 to perform different exercises than the children 114 and 115. For instance, the instructor could instruct the children 111 and 112 to perform the Setu Bandha Sarvangasana pose, also known as the bridge pose, and imagine traveling over a bridge on the train engine. The instructor 113 could then direct the children 114 and 115 to perform the Vriksasana pose, also known as the tree pose, as they imagine traveling through a forest on the train car because their mat 120 has not yet reached the imaginary bridge. The instructor 113 could then direct the children 114 and 115 to perform the Vriksasana pose as their train car mat went onto the imaginary bridge.

The second method of use has the additional advantage of allowing the instructor 113 to teach children with different skill levels within a single class. By being able to select particular exercises by mat, the instructor 113 can provide different instruction to children 111 and 112 as compared to children 114 and 115.

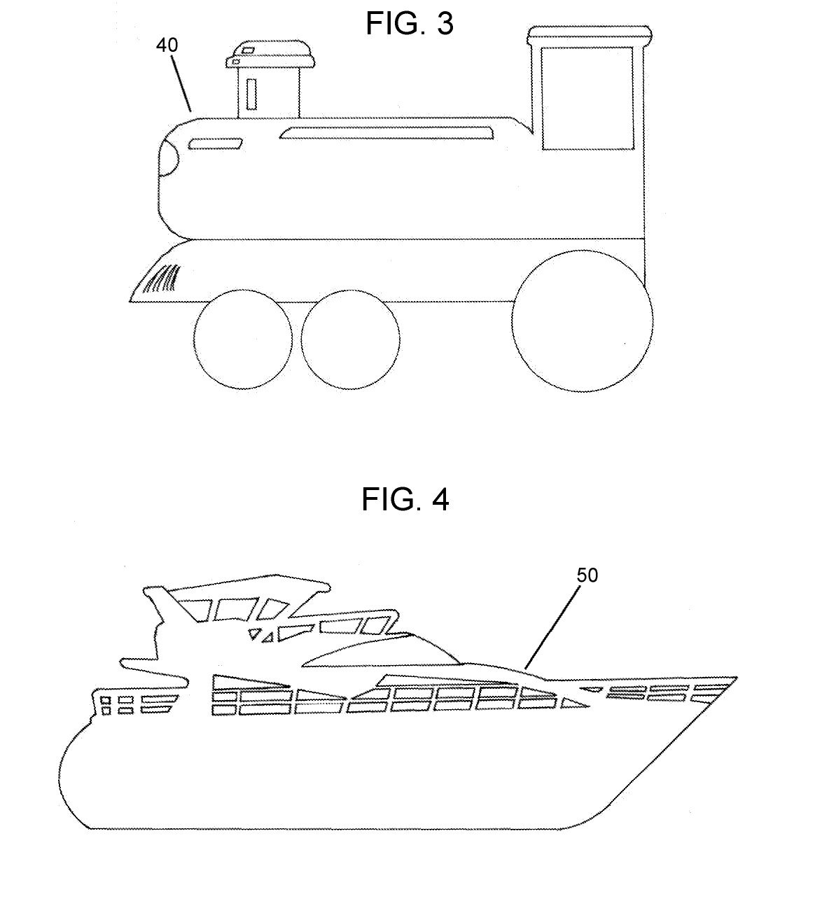

In FIG. 3 is a top view of a third embodiment of the invention, also a train shaped mat 40. As with the other embodiments, the third embodiment may be cut from a continuous sheet of material or cut from various pieces of material and fixed together to form the desired shape. The train shaped mat 40 may be used in conjunction with other shaped mats or alone as desired. The train shaped mat 40 may be used with additional mats with a train theme, including but not limited to train cars, a caboose and a bridge, in the instruction of yoga. The train themed yoga exercises described in the first and second method of use would be applicable with the train shaped mat 40.

Similar to the other embodiments disclosed herein, the train shaped mat 40 is substantially flat when in use and has a center portion that is large enough for at least one child to perform yoga. Extending laterally from the center portion is a fringe portion that terminates at an edge that defines the shape of the mat. The fringe portion is in excess of the amount of surface area that a child needs to practice yoga and is added for the purpose of defining a particular shape when viewed from above, in this case, a train engine.

In FIG. 4 is a top view of a fourth embodiment of the invention, a boat shaped mat 50. As with the other embodiments, the fourth embodiment may be cut from a continuous sheet of material or cut from various pieces of material and fixed together to form the desired shape. The boat shaped mat 50 may be used in conjunction with other shaped mats or alone as desired.

The boat shaped mat 50 may also be used with additional mats with a water theme. For instance, additional mats in the shape of ocean creatures, including but not limited to whales, sharks and octopuses, could be used in the instruction of yoga. Using the water theme, a particularly applicable yoga pose for use on the boat shaped mat 50 is the dolphin or shark pose. As an alternative pose for beginner students, an instructor could have children pose with their arms in the shape of the letter “C” to mimic a shark's mouth.

Using the water theme, an instructor could have students perform a breathing exercise designed to mimic a whale surfacing. A whale breathing exercise could include breathing in deeply through the nose, holding one's breath momentarily, exhaling through the nose and then breathing in deeply through the nose. While this breathing exercise is designed to mimic a whale's breathing, it could optionally be performed by inhaling and exhaling through the mouth.

Also using the water theme, an instructor can direct students to perform a stretching exercise in a motion that mimics an octopus. The octopus stretching exercise would include standing and wiggling one's arms loosely for a period of time. The octopus stretching exercise could be completed in other than the standing position or while performing a breathing exercise.

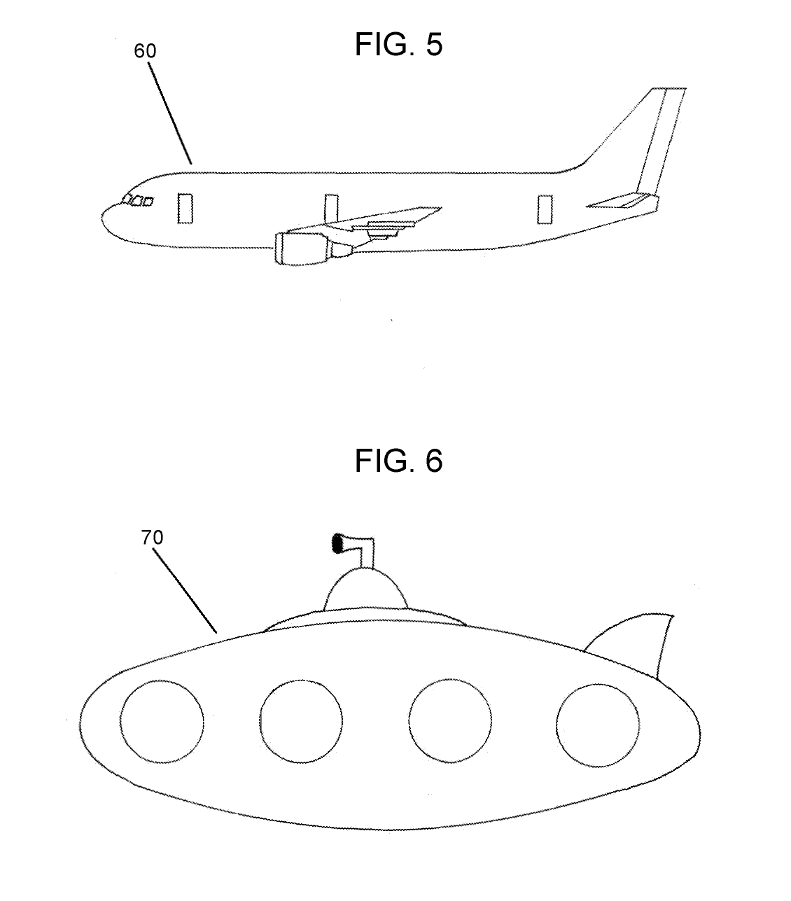

In FIG. 5 is a top view of a fifth embodiment of the invention, an airplane shaped mat 60. As with the other embodiments, the fifth embodiment may be cut from a continuous sheet of material or cut from various pieces of material and fixed together to form the desired shape. The airplane shaped mat 60 may be used in conjunction with other shaped mats or alone as desired.

The airplane shaped mat 60 may also be used with additional mats with a flight or sky theme. For instance, additional mats in the shape of other flying objects or objects in the sky, including but not limited to birds, other airplanes and the sun, could be used in the instruction of yoga. When using a flight or sky theme, a particularly applicable yoga pose for use on the airplane shaped mat 60 is the Dekasana pose, also known as the airplane pose.

In FIG. 6 is a top view of a sixth embodiment of the invention, a submarine shaped mat 70. As with the other embodiments, the sixth embodiment may be cut from a continuous sheet of material or cut from various pieces of material and fixed together to form the desired shape. The submarine shaped mat 70 may be used in conjunction with other shaped mats or alone as desired. The submarine shaped mat 70 may also be used with additional mats with the ocean theme previously described.

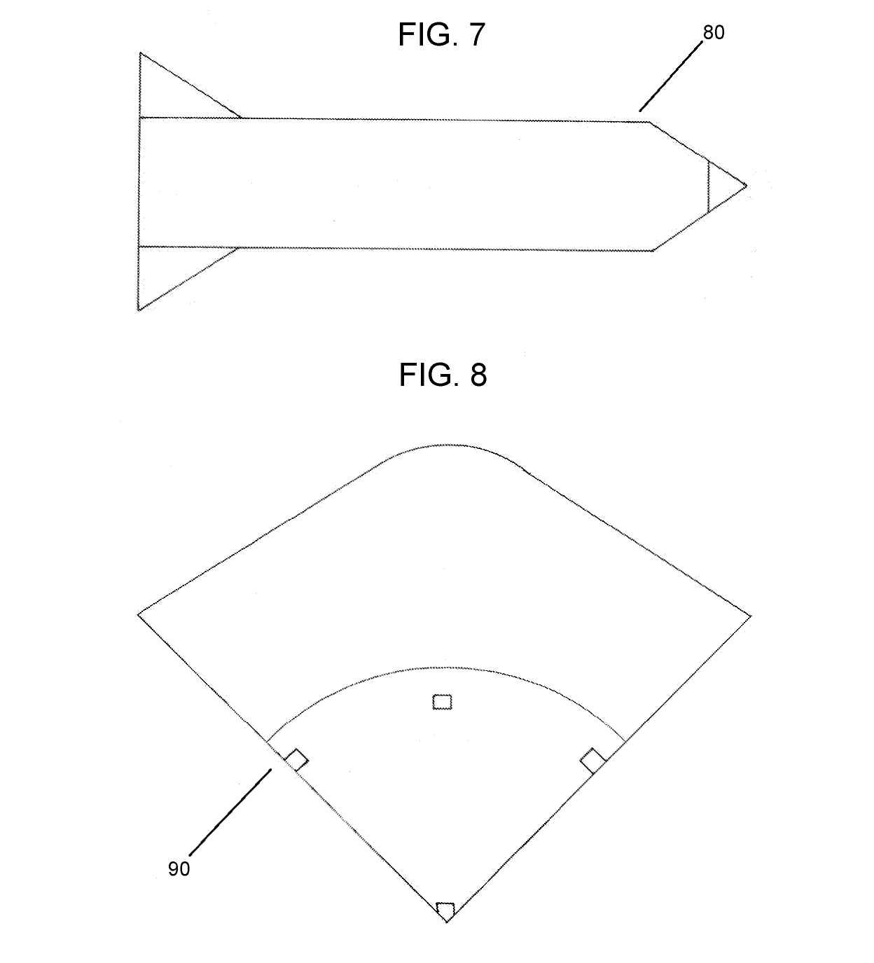

In FIG. 7 is a top view of a seventh embodiment of the invention, a rocket shaped mat 80. As with the other embodiments, the seventh embodiment may be cut from a continuous sheet of material or cut from various pieces of material and fixed together to form the desired shape. The rocket shaped mat 80 may be used in conjunction with other shaped mats or alone as desired.

The rocket shaped mat 80 may also be used with additional mats with the flight or sky theme previously described. The rocket shaped mat 80 may also be used with additional mats with an outer space theme. For instance, additional mats in the shape of other objects in outer space, including but not limited to stars, the moon and the space shuttle, could be used in the instruction of yoga. When using an outer space theme, particularly applicable yoga poses for use on the rocket shaped mat 80 are the Ardha Chandrasana pose, also known as the crescent moon pose, and the star pose.

In FIG. 8 is a top view of an eighth embodiment of the invention, a baseball diamond shaped mat 90. As with the other embodiments, the eighth embodiment may be cut from a continuous sheet of material or cut from various pieces of material and fixed together to form the desired shape. The baseball diamond shaped mat 90 may be used in conjunction with other shaped mats or alone as desired.

The baseball diamond shaped mat 90 may also be used with additional mats with a baseball or sports theme. For instance, additional mats in the shape of objects used in baseball or other sports, including but not limited to baseballs, baseball gloves, bats, footballs, football fields and a soccer ball, could be used in the instruction of yoga.

The baseball diamond shaped mat 90 may also be used alone in a yoga routine that mimics the game of baseball. Using a baseball diamond shaped mat 90 capable of holding more than one child, an instructor could direct the children to stand on bases or field positions and hold yoga poses there. The instructor could direct the children to a specific location or to perform a specific yoga pose randomly or through the use of a secondary game for the purposes of choosing a child's location on the mat or specific yoga pose.

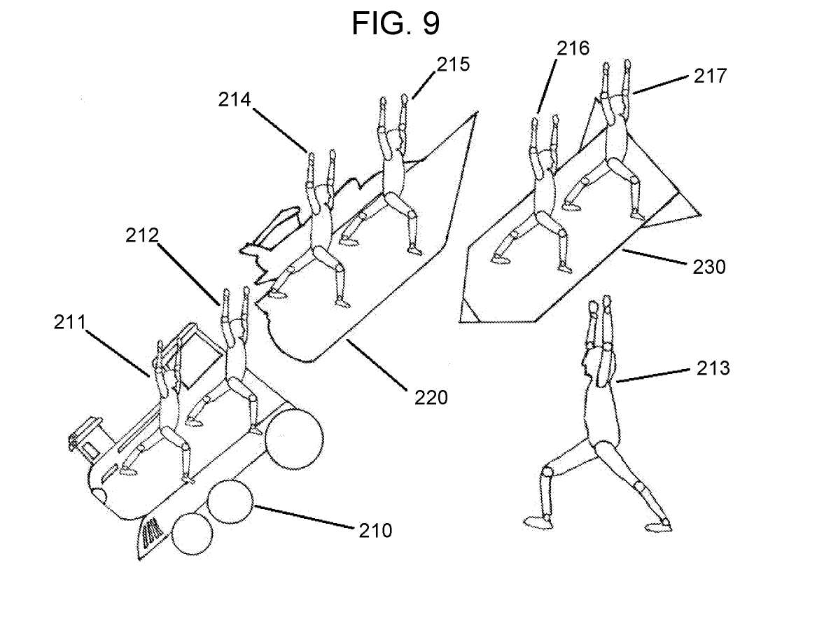

In FIG. 9 is an isometric view of a ninth exemplary embodiment of the invention shown in a third method of use. In the ninth embodiment of the invention is a first mat 210 cut into the shape of a first mode of transportation, a second mat 220 cut into the shape of a second mode of transportation and a third mat 230 cut into a third mode of transportation. For illustrative and explanative purposes, the first mat 210 is cut into the shape of a train engine, the second mat 220 is cut into the shape of a boat and the third mat 230 is cut into the shape of an airplane.

While six children 211-217 are pictured in FIG. 9, the ninth exemplary embodiment of the invention could be used with as few as one child. The size of the mats 210, 220 and 230 can also be increased to accommodate more than two children per mat or additional mats of approximately the same size could be added to accommodate more children in the class.

As with the other methods of use, the instructor 213 can be a person or an electronic device used to deliver instruction, such as a television or computer. The addition of a third mat 230 over the other methods of use allow the instructor to increase the variety of the yoga instruction delivered to the children 211-217. For example, the use of three different modes of transportation allows the instructor 213 to direct the children to imagine being on each one of the modes of transportation for a portion of the class. The children 211-217 can either physically move between the mats 210, 220 and 230 or imagine being on an alternative mat.

The use of mats in the shape of multiple modes of transportation also allows the instructor 213 to describe traveling to different locations around the world that can be accessed by land, sea or air. To help the children 211-217 picture the locations described by the instructor 213, a yoga mat depicting a map of the world could be used. The optional yoga mat depicting a map of the world could be a standard sized yoga mat or it could be a large yoga mat covering a large area of the room. In addition, the optional yoga mat depicting a map of the world could be applied as a flooring material so that the transportation themed mats could be placed on particular parts of the world map. By using the multiple modes of transportation and optionally the world map, the instructor 213 would be able to direct the children 211-217 through yoga exercises that related back to the shape of the mats 210, 220 and 230.

In addition to the themes disclosed above, the following non-exclusive list of themes could also be appropriate for use in generating yoga mat shapes and/or exercises: transportation, trains, bodies of water, maps, outer space, sports, animals and ocean creatures. In addition to the shapes disclosed above, the following non-exclusive list of shapes could also be appropriate for use in generating yoga mat shapes: an airplane, a train, a boat or other vessel, a submarine, a rocket, a space shuttle, an ocean creature, a map or portions thereof, an animal, a celestial body, an object used in a sport and a sport playing surface (for instance, a baseball diamond, a football field, a soccer field or a basketball court).

What has been described are children's yoga mats and methods of use to encourage children to practice yoga. While this disclosure shows the invention as specifically shaped mats and specific methods of uses, all or part of the invention is capable of being used in other applications. In this disclosure, there is shown and described only the preferred embodiment of the invention, but, as aforementioned, it is to be understood that the invention is capable of use in various other combinations and environments and is capable of changes or modifications within the scope of the inventive concept as expressed herein.

What is claimed is:

1. A yoga mat system comprising at least a first yoga mat that is substantially flat when in use, comprising:
a center portion capable of providing a surface for one or more children to practice yoga; and
a fringe portion extending laterally from the center portion and terminating at an edge, where the edge defines a shape, where said shape is of a person, place or thing when viewed from above.

2. The yoga mat of claim 1 wherein said shape is selected from the group consisting of an airplane, a train, a boat or other vessel, a submarine, a rocket, a space shuttle, an ocean creature, a map, an animal, a celestial body, an object used in a sport and a sport playing surface.

3. The yoga mat system of claim 1 wherein said shape of said first yoga mat is a train engine.

4. The yoga mat system of claim 1 wherein said shape of said first yoga mat is selected from the group consisting of a train engine, a train car, a train caboose and a bridge.

5. The yoga mat system of claim 1 further comprising an image fixed to an upper surface of the first yoga mat.

6. A method of manufacturing a yoga mat that is substantially flat when in use, comprising a center portion capable of providing a surface for one or more children to practice yoga, and a fringe portion extending laterally from the center portion and terminating at an edge, where the edge defines the shape of a person, place or thing when viewed from above, comprising the steps of:
cutting one or more sheets of yoga mat material into at least two shapes; and
fixing the two or more shapes together to form a larger shape.

7. The method of claim 6 wherein said shapes are cut from at least two different sheets of yoga mat material with a different color from one another.

8. The method of claim 7 further comprising the step of asking an intended user of the yoga mat to specify a shape and fixing two or more shapes of yoga mat material together to form an edge defining the specified shape when viewed from above.

9. The method of claim 8 wherein said specified shape is selected from the group consisting of an airplane, a train, a boat or other vessel, a submarine, a rocket, a space shuttle, an ocean creature, a map, an animal, a celestial body, an object used in a sport and a sport playing surface.

10. The method of claim 8 further comprising the step of fixing an image to an upper surface of the yoga mat.

11. A method of yoga instruction for children comprising the steps of:
providing a first child with a yoga mat that is substantially flat when in use, comprising a center portion capable of providing a surface for one or more children to practice yoga; and a fringe portion extending laterally from the center portion and terminating at an edge, where the edge defines the shape of a person, place or thing when viewed from above; and
directing said first child to perform one or more yoga exercises that relate to said shape, where relation can be through the name of the exercise, the position held in the exercise, by the motions completed in the exercise or by the sounds created when performing the exercise.

12. The method of claim 11 wherein said shape is the silhouette of a train engine and one or more said yoga exercises are selected from the group consisting of the Setu Bandha Sarvangasana pose, also known as the bridge pose, the Vriksasana pose, also known as the tree pose, the Tadasana pose, also known as the mountain pose, the Balasana pose, also known as the flower pose, the Ardha Chandrasana pose, also known as the crescent moon pose, the rainbow pose and the star pose.

13. The method of claim 11 further comprising a second child with a second yoga mat that is substantially flat when in use, comprising a center portion capable of providing a surface for one or more children to practice yoga; and a fringe portion extending laterally from the center portion and terminating at an edge, where the edge defines the shape of a person, place or thing when viewed from above

14. The method of claim 13 wherein said shape of the first yoga mat is a train engine, said shape of the second yoga mat is a train car.

15. The method of claim 14 wherein one or more said yoga exercises are selected from the group consisting of the Setu Bandha Sarvangasana pose, also known as the bridge pose, the Vriksasana pose, also known as the tree pose, the Tadasana pose, also known as the mountain pose, the Balasana pose, also known as the flower pose, the Ardha Chandrasana pose, also known as the crescent moon pose, the rainbow pose and the star pose.

16. The method of claim 11 further comprised of selecting a theme and providing a second child with a second yoga mat that is substantially flat when in use, comprising a center portion capable of providing a surface for one or more children to practice yoga; and a fringe portion extending laterally from the center portion and terminating at an edge, where the edge defines the shape of a different person, place or thing when viewed from above than the first yoga mat; wherein said shape of the first and second yoga mat conform to the selected theme.

17. The method of claim 16 where said theme is selected from the group consisting of transportation, trains, bodies of water, maps, outer space, sports, animals and ocean creatures.

18. The yoga mat system of claim 3 where said center portion of said first yoga mat is sized to allow two children to simultaneously practice yoga on its upper surface.

19. The yoga mat system of claim 18 further comprising a second yoga mat, said second yoga mat comprising:
a center portion capable of providing a surface for one or more children to practice yoga; and
a fringe portion extending laterally from the center portion and terminating at an edge, where the edge defines a shape, where said shape is selected from the group consisting of a train engine, a train car and a train caboose.

20. The yoga mat system of claim 19 further comprising an elongate member extending between the edge of said first yoga mat and to the edge of said second yoga mat.
